(19) United States
(12) Patent Application Publication
(10) Pub. No.: US 2005/0200516 A1
(43) Pub. Date: Sep. 15, 2005

(54) Retrodirective noise-correlating (RNC) radar methods and apparatus

(75) Inventor: Elliott R. Brown, Glendale, CA (US)

Correspondence Address: Physical Domains, P.O. Box 1574, La Canada, CA, 91012, US

(73) Assignee: Physical Domains

(21) Appl. No.: 11/043,745

(22) Filed: Jan. 25, 2005

Related U.S. Application Data
(60) Provisional application No. 60/538,979, filed on Jan. 26, 2004.

(51) Int. Cl. G01S 13/72

(52) U.S. Cl. 342/90; 342/95; 342/97; 342/189; 342/91; 342/101

(57) ABSTRACT

Embodiments of the present invention provide retrodirective noise-correlating radar that include: (1) a transmit antenna array that quiescently transmits random noise; (2) a receive antenna array, in a desired spatial relationship with the transmit antenna array, for collecting the reflected noise from a target; and (3) RF electronic components interconnecting antenna-element pairs between the receive and transmit arrays. In one group of embodiments, the radar automatically transforms the broad pattern from each element of the array (when transmitting or receiving random noise), to a narrow pattern characteristic of the entire array. In a second group of embodiments, a presence of a target and its range are determined quickly by a quasi-coherent build-up of signal in the time or frequency domains. In third group of embodiments a target angle and velocity vector are determined by cross correlation between two or more electronic channels connecting the transmit and receive arrays.

### RELATED APPLICATIONS

This application claims benefit to U.S. Provisional Patent Application No. 60/538,979 filed on Jan. 26, 2004 which is incorporated herein by reference as if set forth in full herein.

### US GOVERNMENT RIGHTS

A portion of the inventions disclosed and potentially claimed herein were made with Government support under Contract Number MDA972-03-C-0099. The Government has certain rights. Not all inventions disclosed herein were developed or conceived with government funding and it is not intended that the government attain rights in such inventions.

### FIELD OF THE INVENTION

The present invention relates generally to electromagnetic radiation transmission and detection methods and apparatus, and more particularly to radar methods and apparatus that use retrodirective antennae configurations. Particular embodiments provide radar methods and apparatus employing quiescent noise transmission with noise-correlative signal processing.

### BACKGROUND OF THE INVENTION

In Modern Radar System Analysis, published by Artech House,1988, D. K. Barton said, “Radar has been described as a mature art because the basic scientific principles are well understood, and the problem areas are steadily yielding to an advancing technology. Some of these problems have been recognized from the early days of radar, but remain only partially solved today. Especially in search operations, where the required coverage volume (solid angle, range, and Doppler) is large, the design limitations and trade-offs offer limitless opportunities for further effort by systems engineers and designers.”

Various radar methods and apparatus have been used or proposed in the past. Historically, radar has typically been designed and implemented for mid- to long-range applications such as air defense, air traffic control, and collision avoidance. In these applications the response times are long enough that the radar design need not be emphasized for fast detection and acquisition, but instead high sensitivity and high resolution (i.e., spatial and/or Doppler). As such, when applied to short-range applications such as urban protection, conventional radars must usually be “cued” by another system, such as an ultrasonic sensor.

Most, if not all, previous “active” radars have been designed to operate with a “single-pass” of radiation between the transmitter and receiver. This radiation can be coherent (e.g., sinusoidal), incoherent (e.g., additive white Gaussian noise, AWGN), or quasi-coherent. But it is used only once in the target detection process, usually by transmission and reflection. In the context of the present application, “active radar” means a transmitter/receiver combination, or the like, that transmits electromagnetic radiation in some way toward a target and then receives by reflection of the same radiation, or by related phenomenology, a return signal useful for the purpose of target detection.

A retrodirective antenna array for use as an electromagnetic reflector was described by Van Atta in 1959, in U.S. Pat. No. 2,908,002, using feedhorn-type antennas. This patent is hereby incorporated herein by reference as if set forth in full. Van Atta showed how the arrangement of transmit and receive antenna arrays should occur symmetrically about a geometric center point, and how the retrodirective re-transmission of received radiation would occur automatically if the time delay between the symmetric pairs was equal. However, the invention of Van Atta was strictly a passive reflector component. Van Atta did not address the integration of the retrodirective array into a radar itself by the addition of active (gain) electronics between each receive antenna element and the conjugate transmit element.

A need exists in the radar field for improved transmit and receive apparatus and techniques, particularly for short range work, that can automatically detect and track a target without the need for a separate sensor to provide cueing.

A need also exists in the field for sensors that can detect very small targets, such as ballistic projectiles, moving very fast and at close range. In such systems, the detection and acquisition times of the radar should preferably be short compared to the time-of-flight of such projectiles.

### SUMMARY OF THE INVENTION

A first objective of certain embodiments of the invention is to integrate a retrodirective antenna with a radar system, the retrodirective antenna being designed to receive radiation from a certain direction in space and then transmit it back in the same direction.

A second objective of certain embodiments of the invention is to provide a radar system having RF coupling electronics between a given receive antenna element and a particular transmit element.

A third objective of certain embodiments of the invention is to provide a radar having quiescent noise illumination from the transmitter and noise-correlative signal processing in the receiver to detect the presence of targets.

Other objects and advantages of various embodiments and aspects of the invention will be apparent to those of skill in the art upon review of the teachings herein. The various embodiments or aspects of the invention, set forth explicitly herein, or otherwise ascertained from the teachings herein, may address one or more of the above objects alone or in combination, or alternatively may address some other object of the invention ascertained from the teachings herein. It is not necessarily intended that all objects be addressed by any single aspect of the invention even though that may be the case with regard to some aspects.

In a first aspect of the invention a transmit and receive apparatus, includes a transmit antenna array that quiescently transmits noise; a receive antenna array, in a desired spatial relationship with the transmit antenna array, for receiving transmitted noise that is reflected from a target; RF electronic components, interconnecting specific elements of the receive antenna array to specific elements of the transmit antenna array, wherein the transmit antenna array, the receive antenna array, and the RF electronic components are configured to transform a broad pattern from each individual element of the transmit antenna array, to a narrow solid-angle pattern for the elements of the transmit antenna array acting together.

In a second aspect of the invention, a transmit and receive apparatus, includes a transmit antenna array that quiescently transmits noise; a receive antenna array in a desired spatial relationship with the transmit antenna array, for receiving transmitted noise that is reflected from a target; RF electronic components, interconnecting specific elements of the receive antenna array to specific elements of the transmit antenna array, wherein an antenna to target range is determined, at least in part, by a time domain signature as quasi-coherence builds up.

In a third aspect of the invention, a transmit and receive apparatus, includes a transmit antenna array that quiescently transmits noise; a receive antenna array, in a desired spatial relationship with the transmit antenna array, for receiving transmitted noise that is reflected from a target; RF electronic components, interconnecting specific elements of the receive antenna array to specific elements of the transmit antenna array; wherein the target angle is determined, at least in part, by cross-correlation between two elements in the receive antenna array.

In a fourth aspect of the invention a transmit and receive method includes: transmitting quiescent noise via an transmit antenna array; receiving transmitted noise that is reflected from a target via a receive antenna array that configured in a desired spatial relationship relative to the transmit antenna array; interconnecting the receive antenna array to the transmit antenna array via one or more electronic components, wherein the transmit antenna array, the receive antenna array, and the electronic components are configured to transform a broad transmission pattern from each individual element of the transmit antenna array, to a narrow solid-angle pattern for the transmit antenna array of elements acting together.

In a fifth aspect of the invention a transmit and receive method includes: transmitting quiescent noise via an transmit antenna array; receiving transmitted noise that is reflected from a target via a receive antenna array that configured in a desired spatial relationship relative to the transmit antenna array; interconnecting the receive antenna array to the transmit antenna array via one or more electronic components, wherein an antenna to target range is determined, at least in part, by a time domain signature as quasi-coherence builds up.

In a sixth aspect of the invention a transmit and receive method includes: transmitting quiescent noise via an transmit antenna array; receiving transmitted noise that is reflected from a target via a receive antenna array that configured in a desired spatial relationship relative to the transmit antenna array; interconnecting the receive antenna array to the transmit antenna array via one or more electronic components, wherein the target angle is determined, at least in part, by cross-correlation between two elements in the receiver antenna array.

In various embodiments of the invention, the target, along with a receive antenna array, and a transmit antenna array is made part of a retrodirective noise correlating (RNC) feedback loop, the various embodiments of the present invention change the temporal nature of the transmitted radiation during the course of target detection. In some embodiments, the “quiescent” transmission is conveniently AWGN or similar radiation in order that the initial transmitted antenna pattern is suitably broad to illuminate targets over a wide solid angle. With each successive pass through the RNC loop, the power becomes increasingly coherent.

Further aspects of the invention will be understood by those of skill in the art upon review of the teachings herein. These other aspects of the invention may provide various combinations of the aspects presented above as well as provide other configurations, structures, functional relationships, and processes that have not been specifically set forth above.

### BRIEF DESCRIPTION OF THE DRAWINGS

FIG. 1A and 1B provide schematic illustrations contrasting conventional (pencil-beam) radar (FIG. 1A) with an embodiment of a retrodirective noise-correlating (RNC) radar system of an embodiment of the invention (FIG. 1B).

FIG. 2 provides a block diagram of an N-channel one-dimensional Van-Atta retrodirective antenna array.

FIG. 3 schematically depicts a one dimensional RNC radar of an embodiment of the invention which is formed by interconnecting each specific pair of elements of a Van-Atta array with large power gain and bandwidth defining components.

FIG. 4 provides a block diagram of two adjacent channels of an RNC radar according to an embodiment of the invention having a Van-Atta retrodirective antenna configuration.

FIG. 5 provides a schematic illustration of a retrodirective noise correlating (RNC) radar feedback loop along with successive passes of a signal around the loop.

FIG. 6 provides a plot of the cross-correlated signal power as a function of time for four passes around the loop showing the transformation from random noise to quasi-coherence.

FIG. 7 depicts a two-dimensional planar retrodirective antenna array.

FIG. 8 depicts a block diagram of a RNC radar using a Pon's antenna architecture that includes a heterodyne radio-frequency electronic channels connecting separate transmit and receive antennas

FIG. 9 depicts a block diagram of an alternative embodiment to that of FIG. 4 in which excess noise is injected into each channel through directional couplers to provide greater range for the RNC radar and greater sensitivity to small targets.

FIG. 10 depicts a block diagram of another alternative embodiment to that shown in FIG. 4 in which a variable pulse-repetition frequency is applied to a fast switch in each channel to provide detection and discrimination of multiple targets.

FIG. 11 provides a block diagram of another embodiment of the invention which explicitly sets forth the existence of delay elements for ensuring equality of the time delay between channels.

### DETAILED DESCRIPTION OF PREFERRED EMBODIMENTS OF THE INVENTION

In a first embodiment of the invention a retrodirective antenna has a Van-Atta architecture. Transmit antenna elements have corresponding receive antenna elements which are electrically coupled. RF coupling electronics include high-gain, band-limited chains of amplifiers, fast switches, and passive components connecting each receive antenna element to a conjugate transmit element. Each such coupling constitutes a “channel.” Target illumination occurs via quiescent noise illumination which is the amplified random noise from the electronics in each channel. Cross correlation is performed between adjacent elements of a receive array by sampling the instantaneous RF power in the respective channels.

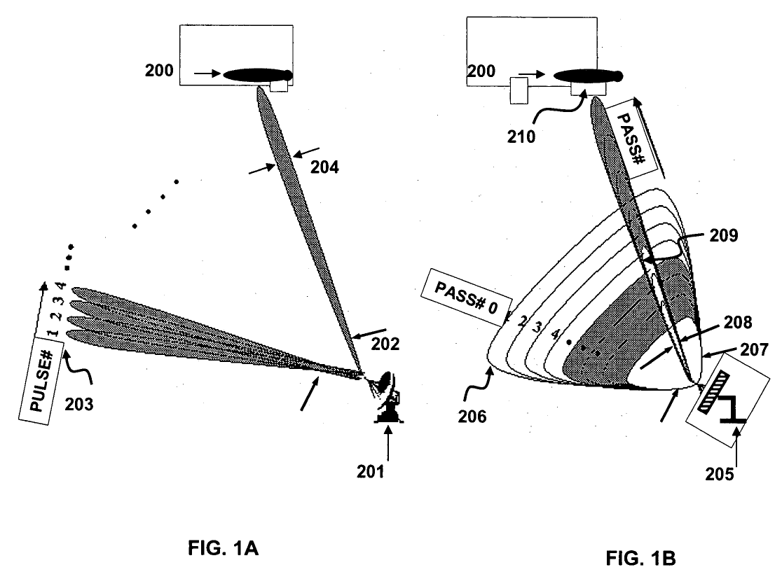

An example of a retrodirective noise-correlating (RNC) radar may be functionally explained in comparison to a conventional, pencil-beam search radar as shown in FIG. 1A. To find a target 200, a pencil-beam radar 201 must scan across a solid angle of space, Ω_{S} 202 either electronically or mechanically. The evolution of time for the pencil-beam radar is depicted in FIG. 1A by the successive transmission of pulses 203. Each pulse is separated from the previous one in time approximately by the round-trip duration of the radiation t_{RT}. Each pulse is separated from the previous one in space by the angular resolution Ω_{B} 204 In this mode, the minimum detection time of a (high radar-cross section) target is roughly Ω_{S}/Ω_{B} (t_{RT}). For a typical beam width of Ω_{B}=1° and a range of 1 km searching over an angle of 90°, this becomes a target detection time of ˜27 ms.

As described in detail below, the RNC radar 205 of FIG. 1B has separate transmit (Tx) and receive (Rx) antenna apertures (not shown), each consisting of one-, two-, or three-dimensional arrays of elemental antennas (not shown). The RNC radar starts in “quiescent mode” by radiating an uncorrelated noise output of each antenna element in the transmitter array, as represented by the zeroth pass output 206 of FIG. 1B. The correlation between elements required for constructive interference is lacking because the signal transmitted is just the additive white Gaussian noise (AWGN) or similar noisy radiation from the electronics in each RNC radar (retrodirective) channel, which starts out uncorrelated. So the radiation is spread over the (broad) beam pattern 207 of each individual element and the total power striking the target depends linearly on the number of elements N in the transmit array.

When a small target 200 suddenly appears, it creates a reflected noise power having non-zero cross-correlation between different points in space or, equivalently, adjacent elements in the receive array. This is a consequence of the van-Cittert Zernike theorem of statistical optics as taught, for example, by M. Born and E. Wolf in “Principles of Optics” (Pergammon, Berlin, 1975). This book is hereby incorporated herein by reference as if set forth in full and provides teachings fundamental phenomenology useful in understanding various objectives of the various embodiments set forth herein.

This cross-correlated component in the receive elements is then fed back to the transmit array in a retrodirective fashion—i.e., in the same direction from which it was received. Under this condition, the cross-correlated signal component is re-radiated into space from the transmit elements with strong constructive interference between elements and, therefore, with strong focusing of the radiated beam 208 compared to the initial beam 207. As the process repeats, the cross-correlated component can in principle grow rapidly with each successive “pass” 209 through the radar 205, leading to automatic pointing of a strong quasi-coherent signal 210 directly at the target 200.

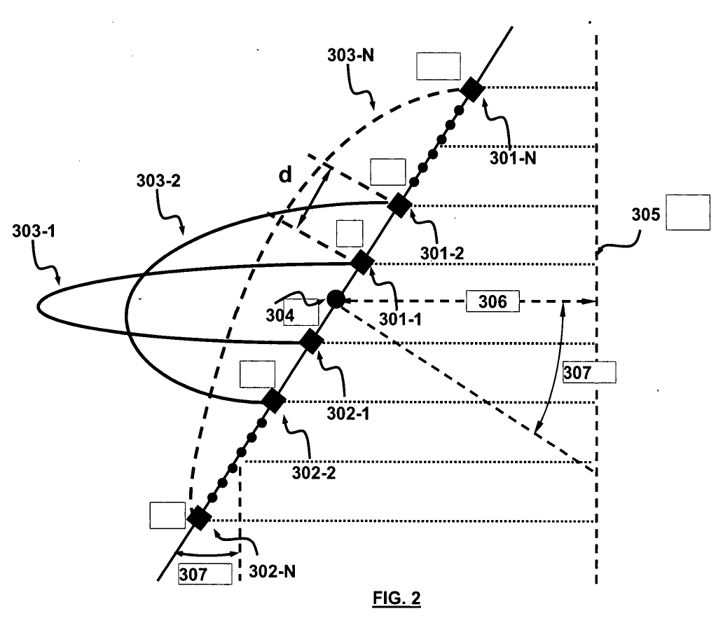

In order to provide the generic capabilities depicted in FIG. 1B, a first objective of certain embodiments of the invention provide a radar employing a retrodirective antenna capability. That is, once the radar receives reflected radiation from a target, it will re-transmit it along the same direction from where it came. A preferred approach to achieve the objective involves use of the Van-Atta array architecture shown in FIG. 2 where each of N elements 301-1 to 301-N of the receive array is connected to a conjugate element 302-1 to 302-N, respectively, of the transmit array such that the electrical (RF) time delay 303-1 to 303-N between each conjugate pair is equal, and each conjugate pair is located symmetrically about the geometric center point 304 of the array. In this case, any radiation received from a target located in the plane 305 at a range R 306 and at angle θ 307 relative to the array will be re-transmitted in the same direction θ.

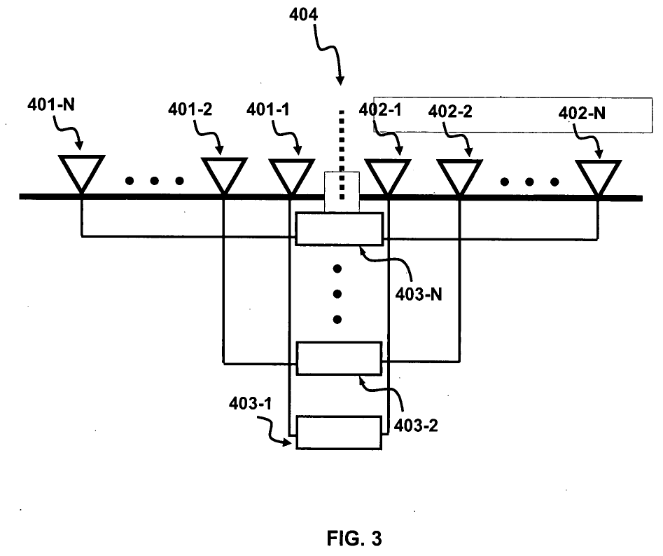

A second objective of certain embodiments of the invention is to provide RF electronics 403-1, 403-2, . . . , and 403-N between respective conjugate pairs of receive and transmit elements (e.g. 401-1 & 402-1, 401-2 & 402-2, . . . , and 401-N & 402-N of the receive and transmit arrays as shown in the block diagram FIG. 3. In one implementation, the electronics are in the form of a chain of gain components (i.e., amplifiers), one or more bandpass filters, one or more fast electronic switches, and passive sampling components. The design maintains the equal time-delay of the retrodirective antenna while providing a very high gain to accelerate the transformation from random noise to quasi-coherence depicted in FIG. 1. In addition, the gain allows this transformation to occur on smaller targets and at greater range from the radar than would otherwise be the case. The bandpass filters are used to limit the gain function to a frequency passband, Δf, over which the antenna elements operate properly. This may be a small fractional bandwidth Δf/f compared to unity. A fast switch in each channel provides a means of limiting the gain by controlling the duty cycle, thereby preventing the radar from oscillating with large targets or those very close in range. In addition, in some embodiments, the presence of high gain makes it preferable to have an electromagnetic isolation layer 404 between the transmit and receive arrays. Those skilled in the art of microwave antennas know that such isolation can be provided by various combinations of RF absorbing materials (RAMs) and metals.

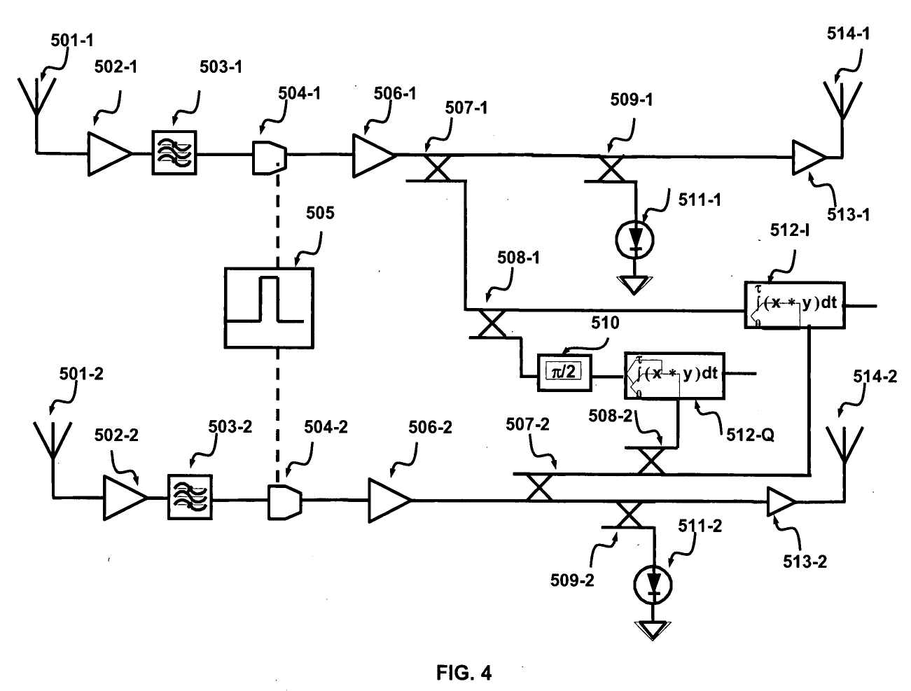

A third objective of certain embodiments of the invention is to provide a radar having quiescent noise illumination and noise-correlative signal processing; The noise illumination is achieved by making the gain in each channel of the radar so large (e.g. ˜60 dB or more) that the physical noise of the RF electronics is intense enough after transmitting through the Tx antennas to produce a measurable reflected power back at the Rx antennas. Noise correlative processing has been utilized in the past but for passive radio astronomy as described by J. Kraus in Radio Astronomy (McGraw Hill, New York, 1966), Chap. 7. This referenced book is incorporated herein by reference as if set forth in full. One approach used in some embodiments of the present Invention is cross-correlative signal processing as shown in the schematic diagram of FIG. 4. A small fraction of the power in each Rx-to-Tx channel is coupled into an analog mixer (connected as a phase detector) where it is multiplied against a comparable level of power from the neighboring channel. The mixer is followed by an integrator to enhance the sensitivity.

One group of embodiments of the present invention is described through the two-channel schematic block diagram of FIG. 4. This block diagram can be scaled to any number of transmit and receive pairs and associated channels to provide various arrays of desired configuration. Similarly, different components may take on different values and properties to provide a variety of different embodiments. The diagram shows two adjacent transmit elements 501-1 and 501-2 and two correlated receive elements 514-1 and 514-2. These receive and transmit elements are, respectively, electrically connected via a plurality of electronic components. Receive element 501-1, transmit element 514-1, and intervening electronic components provide a first channel while receive element 501-2, transmit element 514-2, and intervening electronic components provide a second channel. A low noise amplifier 502-1 or 502-2, respectively, is connected to each receive element. A bandpass filter 503-1 or 503-2, respectively, is connected to each low-noise amplifier. A fast solid-state switch 504-1 or 504-2 respectively is connected to each filter. A fast pulse generator 505 controls each solid-state switch. A moderate-power variable-gain amplifier 506-1 or 506-2, respectively, is connected to each solid state switch to boost the power level and to balance the gain between channels. A directional coupler 507-1 or 507-2, respectively, follow each variable gain amplifier to sample a small fraction of power in each channel for cross-correlation purposes as will be discussed below. A directional coupler 509-1 or 509-2 follow directional couplers 507-1 or 507-2, respectively, sample a small fraction of power in each channel. Such sampling may be used to provide fast envelope or square-law detection. A fast solid-state envelope detector 511-1 or 511-2 follows the respective directional couplers 509-1 and 509-2 respectively. A solid-state power amplifier in each channel 513-1 or 513-2 follows splitters 509-1 and 509-2, respectively, and provides its output to the channel's respective transmit antenna 514-1 or 514-2.

A power splitter 508-1 or 508-2 break up the small fractions of power split off from the channels by splitters 507-1 and 507-2, respectively, into roughly equal portions for cross correlation. A 90-degree phase shifter 510 follows one output of power splitter 508-1 for the quadrature (Q) cross-correlation. A cross-correlator 512-I takes an input from the other output of splitter 508-1 and takes a second input from splitter 508-2 for the in-phase (I) portion between each of the two channels. A second cross correlator 512-Q takes the phased shifted input from 510 and a non-phase shifted input from 508-2 for the quadrature (Q) portion between each channel.

Those of skill in the art will understand that other embodiments or groups of embodiments of the invention may be obtained by varying the order of the components set forth in FIG. 4.

A first feature of some embodiments of the invention is a non-zero cross-correlation of noise reflected from the target, based on the phenomenology stated above. In some embodiments, cross-correlation may be limited to adjacent pairs of elements. In other embodiments, non-adjacent elements may be cross-correlated. In still other embodiments, more than two elements may be cross-correlated. In still other embodiments, no cross-correlation may be used, for example, the signal in each channel may be converted to a digital signal and various algorithms could be utilized to provide desired information, such as target identification.

A second feature of some embodiments of the invention, enabled by the first aspect, is auto-focusing. After reception, all signal power is amplified in each channel and coupled back to the transmit array where it is re-radiated towards the target. There are two components of this re-radiated power: (1) a cross-correlated component between channels that is attributed to reflection from the target, and (2) a random component with no cross-correlation between channels that is primarily physical noise from the electronics. After amplification and re-radiation by the transmit array, the cross-correlated component will constructively interfere in space and produce a radiation pattern characteristic of the total array acting collectively rather than just a single element. As well known from fundamental antenna array theory, the array pattern is significantly narrower in space than the elemental pattern, which constitutes a form of focusing. FIG. 1B illustrates the difference between the array pattern and an individual element pattern qualitatively.

A third feature of some embodiments of the invention is auto-pointing. Because of the retrodirective array configuration, not only does the cross-correlated component of the transmit beam get increasingly focused, but the focusing occurs only in the direction of the target itself. This is inherent to the architecture and requires no external control circuitry or computation.

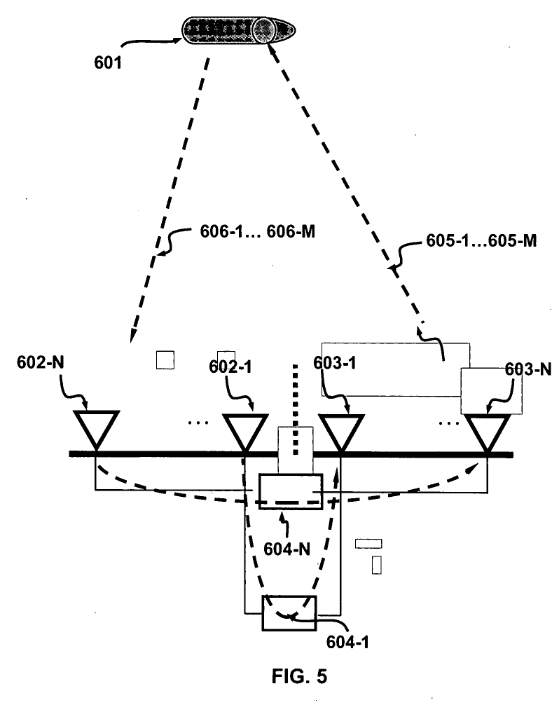

A fourth feature of some embodiments of the invention is auto-amplification. Once the target is close enough to reflect a measurable power back to the receiver, the cross-correlated component of the re-transmitted power can automatically propagate back towards the target with greater intensity than on the first pass. This will create a second reflection back at the receiver containing the same cross-correlated component, and the process repeats as depicted by the RNC feedback loop illustrated in FIG. 5.

FIG. 5 provides a schematic illustration of the RNC radar feedback loop with successive passes of a non-zero cross-correlated signal. The RNC loop includes the target 601; N receive elements 602-1 to 602-N; N transmit elements 603-1 to 603-N; N electronic channels 604-1 to 604-N connecting each receive and transmit element with equal RF gain and time delay; free-space paths 605-1 to 605-M between transmit elements and target; and free-space paths 606-1 to 606-M between target and receive elements.

If the gain of the electronics plus antennas exceeds the losses associated with round-trip propagation through free-space, the non-zero cross-correlated “signal” grows stronger with each loop such that after M loops (e.g. M=2 to 100, 2 to 50, or 2 to 10) the signal grows strong enough to become the basis for target detection. In other words, the condition for detecting a target is similar to the start-up condition for any cavity oscillator or laser, i.e. that the “loop gain” exceeds unity.

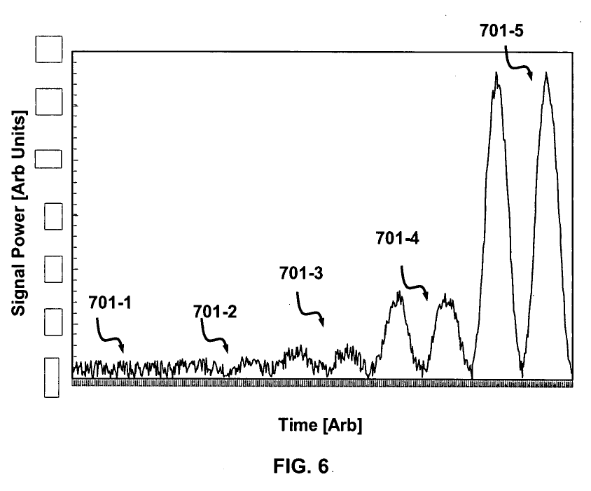

A fifth feature of some embodiments of the invention is ultrafast detection. This occurs when the RNC loop gain exceeds unity by a large enough factor that the cross-correlated signal grows to become quasi-coherent (i.e., quasi-sinusoidal) in just a few passes, as depicted in the simulation of FIG. 6. Each pass corresponds to approximately two round trips through free space, and is assumed to coincide with the on-pulses generated by component (505) in FIG. 4. The signal power versus time shows the quiescent state (701-1) before the target appears, the signal after one pass (701-2), the signal after two passes (701-3), the signal after three passes (701-4), and the signal after four passes (701-5). For this particular simulation, the conditions are such that the signal clearly transforms from random noise to a quasi-coherent (i.e., sinusoidal) nature.

The growth process then has a characteristic rate of 1/tₗₒₒₚ=(t_{RT}+t_{G})⁻¹, where t_{RT}=2R/c (c being the speed of light in vacuum; R being the range to the target) is the round-trip time of the radiation through free space, and t_{G} is the “group” delay of signal power through each electronic channel. For targets at the close ranges of interest, e.g. R=1 to 1000 m, and t_{RT}=6.7 nanoseconds to 6.7 microseconds. With modern solid-state RF electronics, t_{G} can routinely be decreased below 10 ns. So in most applications, the growth rate will be limited primarily by the speed-of-light: 3.0×10⁸ m/s. This is so fast compared to the velocity of all imaginable targets of interest that the detection time of these targets can be practically instantaneous compared to the detection time by conventional radar.

A sixth feature of some embodiments of the invention is range determination. Given the presence of a target and after several passes through the RNC loop, the cross-correlated component will display a power spectrum that is strongest at frequencies that satisfy the greater-than-unity loop-gain condition. But more specifically, this is a condition on the magnitude of the gain |G|, not the phase. The same condition applied to the phase φ requires φ=2πn=ω·t_{RT}, where n is an integer. The power spectrum in each channel will then show peaks at Δf=Δω/2π=(t_{RT})⁻¹. Knowing the spacing of these peaks by spectrum analysis, one can compute the t_{RT} in near-real-time. And knowing the electronic group delay, one can compute the range R. The peaks in the simulation of FIG. 6 are explained by this reasoning.

A seventh feature of some embodiments of the invention is angular discrimination. The signal growth process described above is similar physically to the start-up phase of a unidirectional cavity oscillator. But unlike an oscillator, the RNC radar can provide angular information about the target that no oscillator ever reveals. In some embodiments, this occurs by taking not just one, but two cross correlations between adjacent channels in the RNC radar: (1) an “in-phase” cross correlation I, and (2) a “quadrature” cross correlation Q, as shown in FIG. 4. As for the power spectrum, both cross correlations can be computed by the radar in near-real-time, allowing the rapid computation of the target angle θ through the operation

$$θ = {sin}^{- 1} [ \frac{λ}{2 π d} {tan}^{- 1} \frac{Q}{I} ] \qquad ( 1 )$$

where d is the inter-element separation.

An eighth feature of some embodiments of the invention is auto-tracking. Each of the seven previously mentioned features of the invention are dynamic in the sense that they change automatically in time with the motion of the target provided that the motion (i.e. speed v_{T} of the target) is slow compared to the round-trip time. Roughly speaking, the target should not move much more than one full target length L during the round-trip time. This can be stated mathematically as v_{T}t_{RT}˜v_{T}(2R/c)<L, or (v_{T}/c)<L/2R, or R<L·c/(2v_{T}). This last inequality becomes a criterion on dynamically-limited range. As a conservative example, we take a small bullet of length 3 cm moving at 1000 m/s, and find R<4500 m.

The auto-tracking capability noted above enables a ninth feature of some embodiments of the invention which is velocity vector determination. One technique for getting the velocity is to combine the range data of the sixth feature with the angle data of seventh feature to compute the target track—a dynamic locus of points representing target location with respect to time. Numerical differentiation of this locus yields the velocity vector.

The ultrafast detection along with fast range, angle, and velocity determination, creates the tenth feature of the some embodiments of the invention, which is fast auto-cueing. This is the ability of the radar to electronically trigger another system in real time, or near-real-time. Such capability is useful for small but ominous targets, such as ballistic projectiles, for which the radar may trigger a counter-system. Projectile counter-systems can be very fast, but they need information from a separate sensor to provide location (range and angle) and, maybe, the velocity of the target. The sooner the counter-system receives this information, the more likely the projectile can neutralize or establish protection against the projectile.

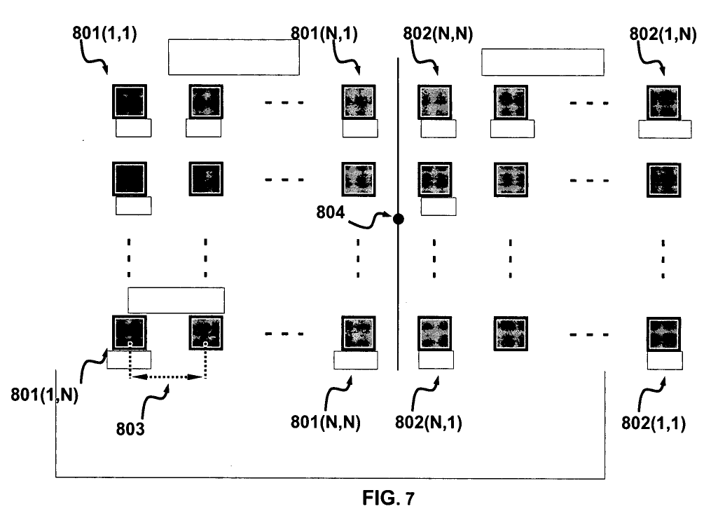

Alternative embodiments to the one-dimensional retrodirective array embodiments of FIGS. 2 to 5, may involve the apparatus and methods that include the use of two-dimensional planar retrodirective antenna arrays. An example of such an array is set forth in FIG. 7. The example of FIG. 7 depicts array of receive elements 801(1,1) to 801(N,N) and a separate array of transmit elements 802(1,1) to 802(N,N) placed symmetrically about a geometric center (804). In some embodiments, the spacing 803 between adjacent elements may be approximately λ/2 where λ is the free-space wavelength of the transmitted radiation. In such a configuration one can still apply the phenomenology of cross-correlation between neighboring elements of the receive array. And the technology of retrodirective feedback between the conjugate antenna pairs will provide the same RNC radar objectives and features as for the one-dimensional array. The advantage of the two-dimensional array is that the autofocusing, autopointing, autotracking, and related aspects will now occur for targets in two dimensions. This is anticipated to be very beneficial to the application of the RNC radar to certain airborne objects, such as projectiles. Equation (1) will then be applied twice to compute two angles, elevation and azumuth, by cross correlating between two separate pairs of adjacent channels. These channels will correspond to orthogonal pairs of antenna elements in FIG. 7.

A secondary advantage of the two-dimensonal array in the present invention is the degree of autofocusing and reduction in detection time. Given a two-dimensional array of roughly equal numbers of elements ˜M×M along the two dimensions, the autofocusing of the RNC radar will occur with a much finer pattern, or higher resolution, than in a one-dimensional array of M elements. In addition, the two-dimensional array will produce greater radiation on target in the quiescent and transformational stages of the radar, leading to greater range for small targets and faster detection time than possible with the M-element one-dimensional array.

In other alternative embodiments three-dimensional transmit and receive arrays antenna arrays may be provided. In simplest form, this would be accomplished by stacking several two-dimensional arrays of FIG. 7 on top of each other with accurate registration between the layers. Retrodirectivity would be provided by interconnecting conjugate elements with respect to a three-dimensional geometric center located in the “wall” between the receive and transmit sides. One advantage of a three-dimensional array over two-dimensional and one-dimensional arrays is range resolution, particularly in the presence of multiple targets. Although the interconnection between conjugate elements is difficult with present RF transmission-line technology, such technology is steadily improving, especially by miniaturization, so that the three-dimensional retrodirective architecture is conceivable.

Still other embodiments may provide other two-dimensional or three-dimensional antenna array patterns.

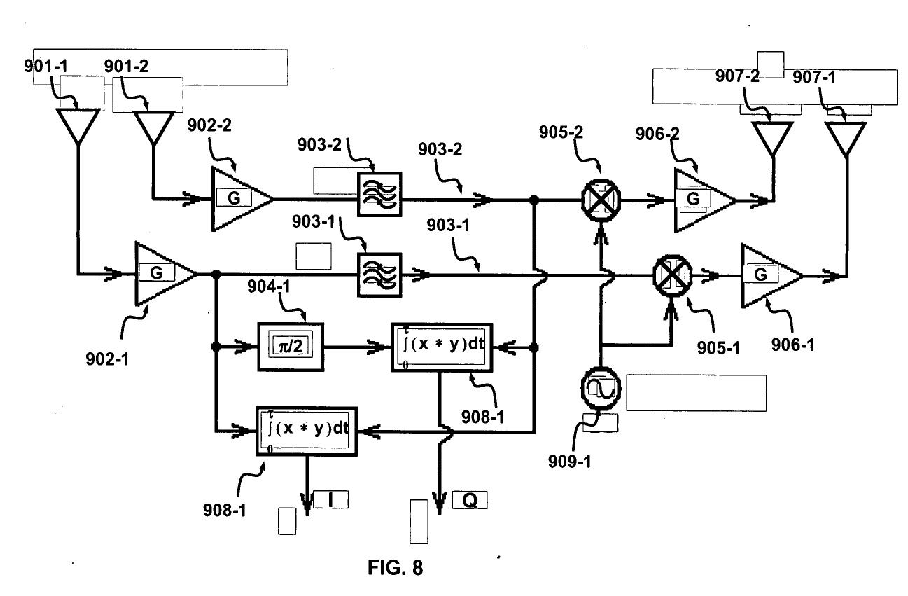

FIG. 8 depicts a block diagram of an alternative embodiment for electronically coupling adjacent pairs of transmit and receive elements. This structure may be referred to as a Pon's architecture. It includes a a heterodyne radio-frequency electronic channel connecting a common transmit/receive antenna. Such a configuration was taught by C. Y. Pon, IEEE Trans. Antennas and Propagation, March 1964, pp.176-180. This article is hereby incorporated herein by reference as if set forth in full herein. In embodiments of this type, retrodirectivity can be maintained by multiplying the incoming band-limited noise in the quiescent state of the RNC radar against a local oscillator 909-1 at approximately twice the frequency of the center of the noise passband. The multiplication is carried out by a respective analog mixer 905-1 or 905-2 in each channel.

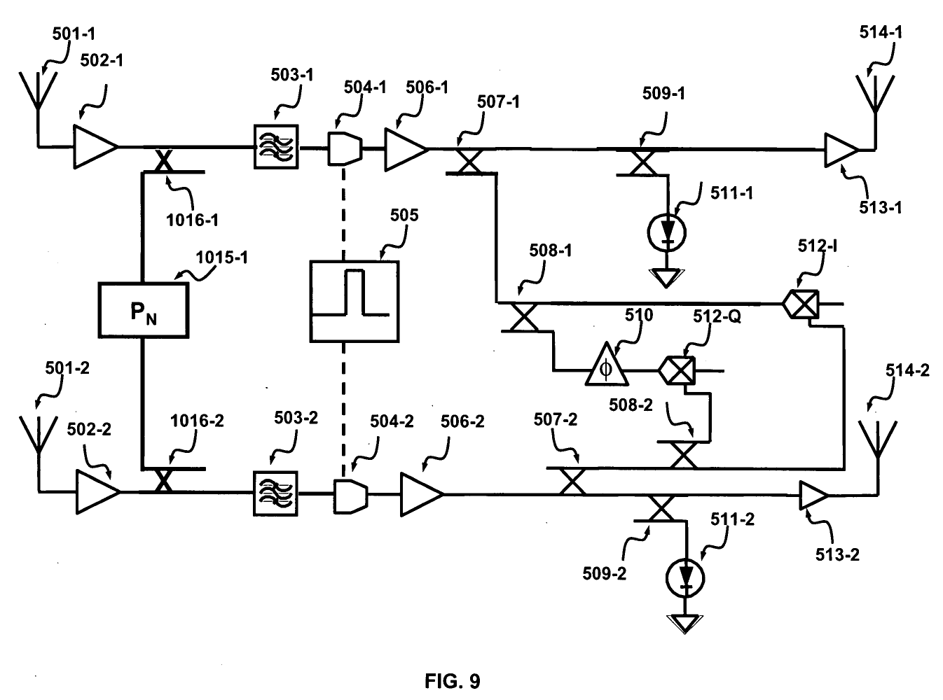

The above embodiments have focused primarily on illumination of the target by the intrinsic noise of the RNC transceiver electronics; however, upon review of the teaching herein, those of skill in the art will understand that further embodiments may be formed by injecting excess noise as shown FIG. 9. The block diagram of FIG. 9 is identical to that of FIG. 4 except that in the quiescent state of the radar, excess noise power P_{N} from an electronic component 1015-1 is injected into each electronic channel. The injection is done through directional couplers 1016-1 and 1016-2 located just after the low-noise amplifier so that most of the electronic gain in each channel would be utilized to boost the injected noise before transmission toward the target. This would have the positive effect of increasing the range of the radar and its sensitivity to smaller targets. A likely device for this powerful injection source would be a solid-state noise diode, common in the microwave field today.

In some alternative embodiments excess noise generation may take the form of pseudorandom noise (PRN). This may, for example, take advantage of the ability of modern high-speed digital electronics to generate a very high rate (usually binary) random bit stream. The advantage over the noise diode approach just described is strength. PRN generation can be done in CMOS and other high-speed digital technologies at the ˜1.0 V level or higher. This corresponds to power levels many orders-of-magnitude higher than typically obtainable from (analog) noise diodes. And the PRN source can be readily controlled by standard digital components, such as microprocessors.

The above alternatives have focused primarily on single targets located within the field of view of the radar; however, upon review of the teaching herein, those of skill in the art will understand that the radar systems of the present invention may be used for multiple target detection and/or acquisition. Such multiple target detection and/or acquisition may for example be implemented via signal processing techniques, such as range gating and adaptive filtering, done in conjunction with backend digital signal processing. In some alternative embodiments, signal processing may be performed via analog front-end electronics.

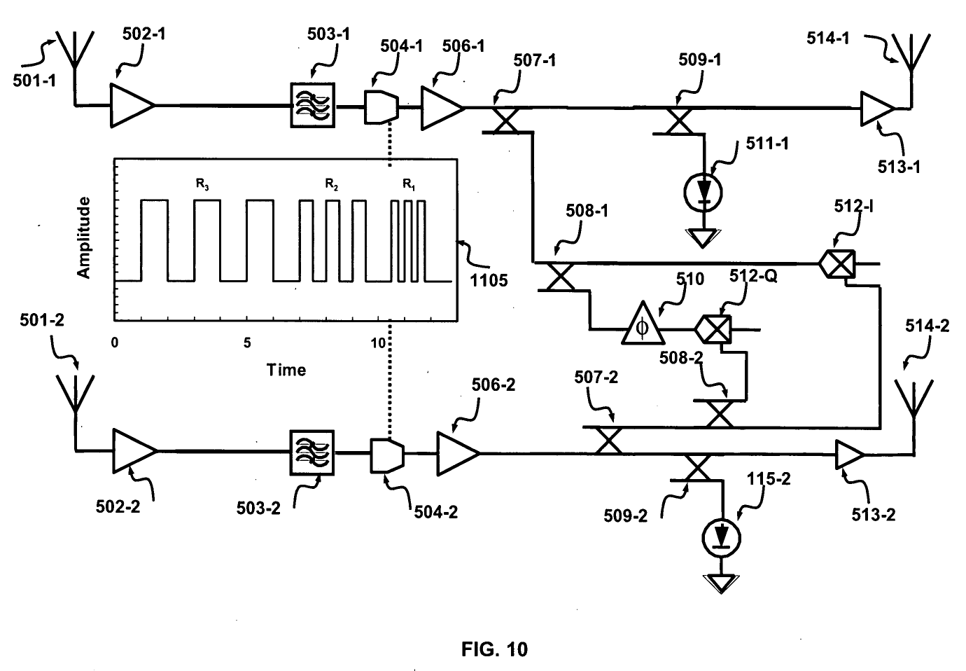

In some embodiments, realization of multiple target detection may be through variation of the pulse repetition frequency (PRF) as illustrated in FIG. 10. This may be achieved by upgrading the pulse generator 505 used to determine range in the embodiment of FIG. 4 to a generator whose PRF is capable of varying (e.g. capable of increasing or decreasing). The increasing case is shown in FIG. 10, where the pulse generator 1105 is indicated as having an increasing frequency. The PRF is varied step-wise with a dwell time on each PRF value of at least two or three round trips through free space. In this way, targets at different ranges could be discriminated by noting at what PRF the power spectrum in each channel displays the random-to-quasicoherent build-up shown in FIG. 6.

The combination of PRF variation of FIG. 10 and the synchronized cross-correlation between adjacent channels in FIG. 4 would allow the determination of both the range and the angle of multiple targets.

In another alternative embodiment, the electronics connecting the transmit and receive antenna pairs is demultiplexed, for example, to provide better target discrimination in the frequency domain or to provide new functionality such as different electronic channels concentrating on different range bins. This may be implemented by integration of the components required by each Tx and Rx pair by either monolithic semiconductor techniques or by compact hybrid packaging.

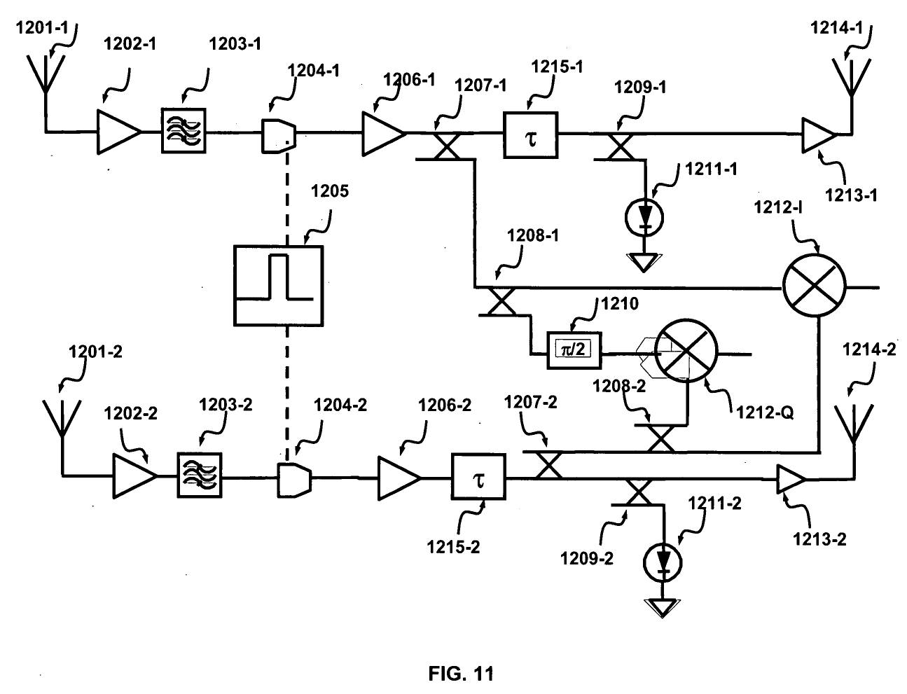

FIG. 11 provides a block diagram of another embodiment of the invention. An RNC radar of this embodiment of the invention includes N/2 pairs of transceiver channels. A sample pair of channels is shown in FIG. 11. The operating frequency is centered at 10 GHz (X band). The transmit antenna includes N/2 pairs of elements 1214-1 and 1214-2 while the receive antenna includes N/2 pairs of elements 1201-1 and 1201-2. In this embodiment the transmit and receive antenna elements are microstrip patch antennas designed to be circularly polarized and have a broadside pattern with a directivity of ˜6 dB. They are matched to 50 ohms and have a minimum return loss at the center frequency of ≈−20 dB or better. The patch antennas and all components are constructed in hybrid fashion using 50-ohm coaxial transmission line to interconnect them.

Each channel contains three semiconductor gain elements, the first one being a low-noise amplifier (LNA) 1202-1 or 1202-2, respectively, having a noise figure of ≈2 dB and a small-signal gain of 25 dB. The next element is a variable gain amplifier 1206-1 or 1206-2, respectively, having gain of 25 dB+/−5 dB that is very useful in matching the overall gain in each channel. The last element is a power amplifier 1213-1 or 1213-2, respectively, having a gain of ˜30 dB and maximum power handling of ˜+30 dBm.

The channel gain is limited to a bandwidth of ˜500 MHz using a bandpass filter 1203-1 or 1203-2, respectively. It is a coupled-microstrip design having a high-order (e.g., 5^{th}) Butterworth filter response. The −3-dB bandwidth is about 500 MHz (˜5%). The filter has a minimum of about 20 dB of rejection either well below or well above the passband.

The RF control component in this embodiment is a fast solid-state switch 1204-1 or 1204-2, respectively located in each of the 1^{st} and 2^{nd} channels. The insertion loss is ˜30 dB in the “off” state, and <2 dB in the “on” state. The rise- and fall-times of the switch are ˜10 ns. The switch is driven by a solid-state pulse generator 1205 having binary output pulses that turn the switch from fully-on to fully-off. The pulse-repetition frequency of the generator can be varied between 1 and 100 MHz to accommodate targets at ranges between about 1 and 100 m.

The power in each channel is sampled using passive coaxial components. A first directional coupler 1207-1 or 1207-2, respectively, samples ˜−10 dB to the cross-correlator, after which a second power splitter 1208-1 or 1208-2, respectively couples −3 dB into both the I cross-correlator 1212-I and Q cross-correlator 1212-Q. A second directional coupler 1209-1 and 1209-2, respectively, in the 1^{st} and 2^{nd} channels sample ˜−20 dB to a fast power detector 1211-1 and 1211-2, respectively, which may, for example, be a Schottky-diode square-law detector because of its superior sensitivity to the alternative envelope detector.

In this embodiment the cross correlators 1212-I and 1212-Q are made with (analog) solid-state double-balanced mixers. A sample from one channel is coupled to the RF port, and a sample from the neighboring channel is coupled to the LO port either in-phase with the RF port (I cross-correlation) or in-quadrature with the RF port (Q cross correlation). The quadrature phase is created by a π/2 coaxial phase shifter 1210. When used in this way, the dc current from the RF port of the mixer (or voltage if this port is terminated in a high impedance) is given by I=A [P_{RF}P_{LO}]^{1/2} cos(φ_{rf}−φₗₒ), where φ_{rf} and φₗₒ are the phases of the signals in the two adjacent channels.

Each channel includes a passive time-delay component 1215-1 or 1215-2, respectively. This is a mechanically-adjustable coaxial-line “stretcher” that is used to equalize the time delay between channels, and thereby establish the retrodirective condition between all antenna elements. Line stretchers provide “true time delay”, so a precise adjustment at one frequency provides equalization across the entire frequency passband. Such time delay elements may be added to the other embodiments as needed to obtain desired equalization of time delays. In other embodiment other time delay elements may be used.

In some embodiments, the various components and elements described herein may be discrete elements while in other embodiments they may be combined into integrated components or component assemblies. In still other embodiments, it will be clear to those of skill in the art that other equivalent or alternative components or component combination may be used to replace components explicitly indicated herein or to enhance functionality of devices set forth herein.

In view of the teachings herein, many further embodiments, alternatives in design, and uses of the instant invention will be apparent to those of skill in the art. As such, it is not intended that the invention be limited to the particular illustrative embodiments, alternatives, and uses described above but instead that it be solely limited by the claims presented hereafter.

1. A transmit and receive apparatus, comprising:
a transmit antenna array that quiescently transmits radiation;
a receive antenna array, in a desired spatial relationship with the transmit antenna array, for receiving transmitted radiation that is reflected from a target;
RF electronic components, interconnecting specific elements of the receive antenna array to specific elements of the transmit antenna array,
wherein the transmit antenna array, the receive antenna array, and the RF electronic components are configured to transform abroad pattern from each individual element of the transmit or receive antenna array, to a narrow solid-angle pattern for the elements of the transmit or receive arrays acting together.

2. The apparatus of claim 1 whereby the narrow solid-angle pattern provides auto-pointing by automatically pointing in the direction of the target.

3. The apparatus of claim 1 whereby the narrow solid-angle pattern automatically tracks the target while it is in motion to provide auto-tracking of the target.

4. The apparatus of claim 3 whereby auto-tracking enables is used, at least in part, to determine a target velocity vector.

5. The apparatus of claim 1 wherein the radiation is noise.

6. The apparatus of claim 5 whereby detection occurs by transformation of quiescently radiated noise toward coherence when a target is present.

7. The apparatus of claim 6 wherein target detection is initiated within a time defined by R/C+a group delay of the RF electronic components, where R=the distance from the receive antenna array to the target, and C=the speed of radiation reflected from the target.

8. A transmit and receive apparatus, comprising:
a transmit antenna array that quiescently transmits radiation;
a receive antenna array in a desired spatial relationship with the transmit antenna array, for receiving transmitted radiation that is reflected from a target;
RF electronic components, interconnecting specific elements of the receive antenna array to specific elements of the transmit antenna array,
wherein an antenna to target range is determined, at least in part, by a time domain signature as quasi-coherence builds up.

9. The apparatus of claim 8 wherein the quasi-coherence comprises a comb of frequencies each separated by the free spectral range C/2*R associated with a target.

10. The apparatus of claim 8 wherein the radiation is noise.

11. The apparatus of claim 10 wherein injection of noise provides increased range of detection and sensitivity to small targets.

12. A transmit and receive apparatus, comprising:
a transmit antenna array that quiescently transmits radiation;
a receive antenna array, in a desired spatial relationship with the transmit antenna array, for receiving transmitted radiation that is reflected from a target;
RF electronic components, interconnecting specific elements of the receive antenna array to specific elements of the transmit antenna array;
wherein the target angle is determined, at least in part, by cross-correlation between two elements in the receive antenna array.

13. The apparatus of claim 12 wherein the two different elements are adjacent elements.

14. The apparatus of claim 12 wherein the two different elements are non-adjacent elements.

15. The apparatus of claim 12 wherein the cross-correlation comprises a multiplication between an in-phase component in a first channel and an in-phase component in a second channel (I-correlation) and a multiplication between an in-phase component in the first channel and a quadrature component of the second channel (Q-correlation).

16. The apparatus of claim 12 wherein detection of multiple simultaneous targets occurs, at least in part, via a variation of a pulse repetition frequency.

17. The apparatus of claim 12 wherein the radiation is noise.
